(19) United States
(12) Patent Application Publication
(10) Pub. No.: US 2022/0003028 A1
(43) Pub. Date: Jan. 6, 2022

(54) REFRIGERATOR

(71) Applicant: BSH Hausgeraete GmbH, Muenchen (DE)

(72) Inventors: Jinghui Chen, Nanjing (CN); Qinchao Liu, Nanjing (CN); Ping Lv, Nanjing (CN); Nanwei Zhang, Nanjing (CN)

(21) Appl. No.: 17/363,313

(22) Filed: Jun. 30, 2021

(30) Foreign Application Priority Data
Jul. 6, 2020 (CN) 202010641171.8

(51) Int. Cl. E05D 11/00; F25D 23/02

(52) U.S. Cl. CPC E05D 11/0081; F25D 23/028; F25D 2400/40; E05Y 2900/31; F25D 2323/024

(57) ABSTRACT

A refrigerator includes a cabinet, a first door located in front of the cabinet, a second door located in front of the first door, an electrical member located at the second door, and a transmission line connected to the electrical member. The transmission line extends from the cabinet into the first door and extends from the first door toward the second door.

### CROSS-REFERENCE TO RELATED APPLICATION

This application claims the priority, under 35 U.S.C. § 119, of Chinese Patent Application CN 202010641171.8, filed Jul. 6, 2020; the prior application is herewith incorporated by reference in its entirety.

### BACKGROUND OF THE INVENTION

### Field of the Invention

Embodiments of the present invention relate to a refrigerator, and in particular, to a refrigerator having a first door and a second door.

In order to provide users with more usage scenarios, one door is disposed in front of another door on a refrigerator, and articles stored in the inner door become accessible when the outer door is opened.

### BRIEF SUMMARY OF THE INVENTION

It is accordingly an object of the invention to provide an improved refrigerator, which overcomes the hereinafore-mentioned disadvantages of the heretofore-known refrigerators of this general type.

With the foregoing and other objects in view there is provided, in accordance with the invention, a refrigerator, including a cabinet, a first door located in front of the cabinet, a second door located in front of the first door, an electrical member located at the second door, and a transmission line connected to the electrical member, in which the transmission line extends from the cabinet into the first door and extends from the first door toward the second door.

The transmission line extends through the first door, so that a space required for a hinge unit on the first door is reduced. For example, it is not necessary for the transmission line from the cabinet to extend into the first door to directly extend toward the hinge unit connecting the first door and the second door, and the transmission line configured to connect the cabinet and the second door extends into the first door to outside of the first door. In one aspect, it is not necessary to construct larger hinge lids because the transmission line is directly exposed between different hinge units. In another aspect, an adaptor connector of the transmission line on the first door is not necessarily limited inside the hinge unit of the first door. In this way, a more compact hinge unit may be obtained. For example, in possible embodiments, the adaptor connector of the transmission line on the first door may be disposed outside the hinge unit connecting the first door and the second door.

It should be understood that terms used in this application such as “extend,” “extend toward,” “enter,” “extend . . . after exiting . . . ” are static descriptions of the transmission line in the refrigerator after all manufacturing procedures are finished. A person skilled in the art should understand that an extension direction of the transmission line in an assembled and static state may be described in a completely opposite direction.

Specifically, the protection scope of the present invention is not related to operations on the transmission line during manufacturing of the refrigerator, and in particular, is not related to extension and operations on different parts of the transmission line during manufacturing of the refrigerator. That is, the protection of the present invention is not limited by the extension direction and operating method of the transmission line during manufacturing.

For example, when this application describes the transmission line extending from the first door toward the second door, during manufacturing, a corresponding part of the transmission line may be pulled from the second door to the first door to connect to another part of the transmission line located at the first door, or a corresponding part of the transmission line may be pulled from the first door to the second door to connect to another part of the transmission line located at the second door.

In possible embodiments, the transmission line may extend into a thermal insulation space, filled with thermal insulation materials, of the first door. Therefore, it is not necessary to additionally provide a channel independent of the thermal insulation space to allow the transmission line to extend within the first door, so that the transmission line may pass through the first door without significantly increasing the structural complexity of the first door.

In possible embodiments, the refrigerator includes a first hinge unit connecting the first door and the second door, where the transmission line enters the first hinge unit after exiting the first door to extend toward the second door.

In possible embodiments, the refrigerator includes a second hinge unit connecting the cabinet and the first door, where the transmission line may extend into the first door through the second hinge unit.

In possible embodiments, the transmission line may extend within the first door and has a distance in a lateral direction of the first door.

In possible embodiments, the transmission line may extend within the thermal insulation space, filled with thermal insulation materials, of the first door, and then extend in the lateral direction of the first door beyond the first hinge unit connecting the first door and the second door and/or beyond the second hinge unit connecting the first door and the cabinet to outside of the thermal insulation space.

In possible embodiments, the transmission line may exit the thermal insulation space of the first door, then extend laterally to extend into the first hinge unit connecting the first door and the second door, and extend toward the second door with the first hinge unit.

In possible embodiments, the first door may include a first accommodating portion located at an end thereof and a lid configured to cover the first accommodating portion, where the transmission line extends from the first door to the first accommodating portion and then extends toward the first hinge unit.

In possible embodiments, the first accommodating portion is adjacent to the first hinge unit connecting the first door and the second door, and there is a pitch or slope in the lateral direction of the first door.

In possible embodiments, the transmission line may include a first electrical connector and a second electrical connector connected in the first accommodating portion, and a cable extending from the second electrical connector into the first hinge unit along the end of the first door.

In possible embodiments, the lid may include a lid portion extending horizontally and a separator portion configured to separate the first hinge unit from the first accommodating portion, where the separator portion is provided with a hole for the transmission line to pass through.

In possible embodiments, the refrigerator may include another electrical part in the first accommodating portion, where the electrical part includes, but is not limited to, at least one of a door detector, a temperature sensor, a humidity sensor, and a control circuit board.

With the objects of the invention in view, there is also provided a refrigerator, including a cabinet, a first door located in front of the cabinet, a second door located in front of the first door, an electrical member located at the second door, a first hinge unit connecting the first door and the second door, and a transmission line configured to transmit electricity/signals to the electrical member, in which the transmission line includes a first connector and a second connector that are connected at the first door, and the first connector and the second connector are located outside the first hinge unit.

In possible embodiments, the first door may include a first accommodating portion located at an end thereof and a lid configured to cover the first accommodating portion, where there is a pitch between the first accommodating portion and the first hinge unit in a lateral direction of the first door, and the first connector and the second connector are located in the first accommodating portion.

In possible embodiments, the transmission line may extend into the first door through a hinge hole located in the first door and extend within the first door to generate a distance in the lateral direction of the first door.

In possible embodiments, the transmission line may extend within the first door in the lateral direction of the first door beyond the first hinge unit connecting the first door and the second door and/or beyond the second hinge unit connecting the first door and the cabinet into the accessible first accommodating portion located at the first door.

Other features which are considered as characteristic for the invention are set forth in the appended claims.

Although the invention is illustrated and described herein as embodied in a refrigerator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings. The structure of the embodiments of the present invention and other inventive objectives and beneficial effects thereof will become more comprehensible from the description of the preferred embodiments with reference to the accompanying drawings.

### BRIEF DESCRIPTION OF THE SEVERAL VIEWS OF THE DRAWING

FIG. 1 is a diagrammatic, partial three-dimensional diagram of a refrigerator having a first door and a second door according to an embodiment of the present invention;

FIG. 2 is a diagrammatic, partial exploded view of a refrigerator having a first door and a second door according to an embodiment of the present invention, where the second door is opened relative to the first door; and

FIG. 3 is a diagrammatic, cross-sectional view of a refrigerator having a first door and a second door according to an embodiment of the present invention.

### DETAILED DESCRIPTION OF THE INVENTION

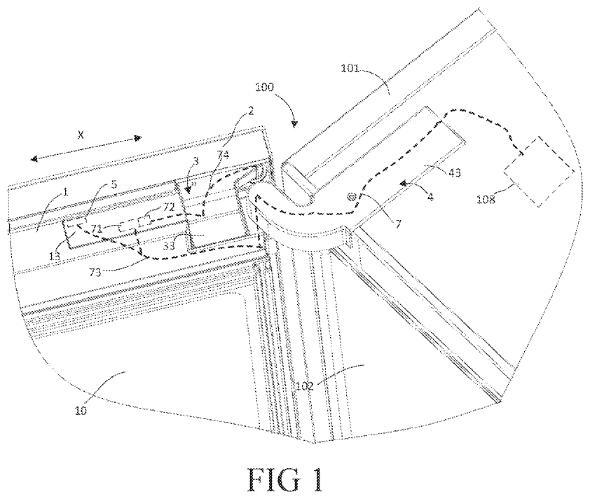

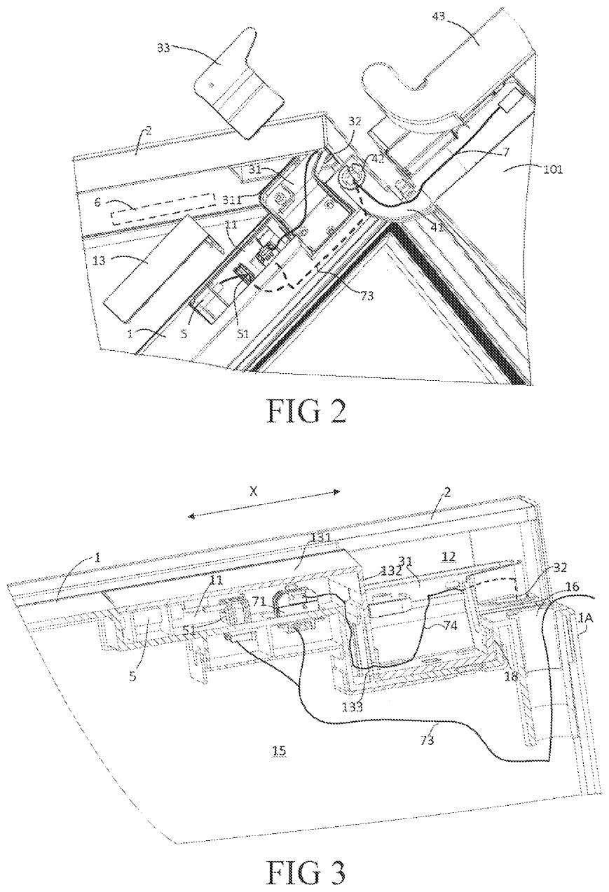

Referring now in detail to FIGS. 1 to 3 of the drawings as a whole, there is seen a refrigerator 100 which includes a cabinet 101. The cabinet 101 includes at least one storage compartment 102 that opens toward the front.

The refrigerator 100 includes a first door 1 located on a front side of the cabinet 101. The first door 1 is movably connected to the cabinet 101 relative to the cabinet, so that the storage compartment 102 is accessible to the user.

The first door 1 may be provided with a storage portion 10 to store articles. In some implementations, the first door 1 may be provided with an opening that passes through the first door in a longitudinal direction of the first door, so that, for example, the storage compartment 102 is observable or accessible from the front side of the first door 1.

In some other implementations, such an opening may not be provided in the first door 1. For example, the storage portion 10 is only accessible from a front side or a rear side of the first door.

A second door 2 is located on the front side of the first door 1. Articles stored in the storage portion 10 of the first door 1 are accessible from the front side of the first door 1 by opening the second door 2.

The refrigerator 100 includes a first hinge unit 3 configured to enable the second door 2 to rotate relative to the first door 1.

The first hinge unit 3 may include a first hinge 31 with one end connected to the first door 1 and the other end connected to the second door 2. The first hinge 31 may include a first hinge shaft 32 extending into the second door 2, and the second door 2 may rotate around a rotation axis defined by the first hinge shaft 32.

The first hinge unit 3 may be connected to the top of the first door 1 and the top of the second door 2. An upper end of the first door 1 may be basically covered by the second door 2.

The first door 1 may be alternatively rotatably connected to the cabinet 101. The refrigerator 100 may include a second hinge unit 4 connecting the first door 1 and the cabinet 101.

The second hinge unit 4 may include a second hinge 41 with one end connected to the first door 1 and the other end connected to the cabinet 101. The second hinge 41 may include a second hinge shaft 42 extending into the first door 1. The top of the first door 1 may include a hinge hole 16 for accommodating the second hinge shaft 42. The first door 1 is rotatable around a rotation axis defined by the second hinge shaft 42.

An end, connected to the first door 1, of the first hinge 31 and an end, connected to the first door 1, of the second hinge 41 are distributed at an interval in the lateral direction of the first door. Compared with an end, connected to the first door 1, of the first hinge 31, an end, fixed on the first door 1, of the second hinge 41 is closer to a first side 1A of the first door 1.

The first hinge unit 3 may include a first hinge lid 33 configured to cover the first hinge 31. A space may be provided between the first hinge lid 33 and the first hinge 31 to accommodate an electrical part such as a cable.

In this embodiment, the first hinge 31 may include an extension portion 311 extending upward from an edge thereof, and a side of the first hinge lid 33 is located on the inner side of the extension portion 311 and connected to the first hinge 31.

The second hinge unit 4 may include a second hinge lid 43 configured to cover the second hinge 41. The second hinge lid 43 may extend to an upper portion of the first door 1 from the cabinet 101. A space may be configured between the second hinge lid 43 and the second hinge 41 to accommodate the electrical part such as the cable.

In an embodiment, the second door 2 may include an electrical member 6 that can consume power. The electrical member 6 may include, but is not limited to, at least one of a lighting element, a display/operation part, a heater, a sensor, and a part adapted to be electrically driven.

The electrical member 6 is electrically connected to a related part 108 (such as a control module and/or a power supply module) on the cabinet 101 by a transmission line 7, to transmit power to the electrical member 6 and/or transmit signals to or receive signals from the electrical member 6.

The transmission line 7 may extend from the cabinet 101 into the first door 1 and extend from the first door 1 toward the second door 2.

The transmission line 7 may extend into a thermal insulation space 15, filled with thermal insulation materials (not shown in the figure), of the first door 1, and extend from the thermal insulation space 15 toward the second door 2.

The transmission line 7 may extend toward the second door 2 through the first hinge unit 3 connecting the first door 1 and the second door 2. The transmission line 7 may extend into the first door 1 through the second hinge unit 4 connecting the cabinet 101 and the first door 1. The transmission line 7 may extend into the first door 1 through the second hinge unit 4.

The transmission line 7 may extend within the first door 1 to generate a distance in the lateral direction of the first door 1. The transmission line 7 extends within the first door 1 and extends in the lateral direction of the first door 1 beyond the first hinge unit 3 to outside of the first door 1.

The transmission line 7 may extend within a thermal insulation space 15, filled with thermal insulation materials, of the first door 1, and then extend in the lateral direction of the first door 1 beyond the first hinge unit 3 and/or beyond the second hinge unit 4 to outside of the thermal insulation space 15. In this embodiment, the transmission line 7 extends in the lateral direction of the first door 1 beyond the first hinge unit 3 and the second hinge unit 4 to outside of the thermal insulation space 15.

The transmission line 7 exits the first door 1 and then extends laterally to extend into the first hinge unit 3. The transmission line 7 extends toward the second door 2 through the first hinge unit 3.

The first door 1 may include a first accommodating portion 11 located at an end thereof and a lid 13 configured to cover the first accommodating portion 11. The lid 13 is detachably mounted on the first door 1, so that parts in the first accommodating portion 11 are accessible. The transmission line 7 may extend into the first accommodating portion 11 from the thermal insulation space 15 of the first door 1. The lid 13 includes a lid portion 131 extending horizontally and a separator portion 132 configured to separate the first hinge unit 3 from the first accommodating portion 11 in a lateral direction of the first door 1, the separator portion having a hole 133 for permitting the transmission line 7 to pass through.

The first accommodating portion 11 may be configured as a concave portion that is concave from an end surface of the first door 1 toward the other end of the first door 1.

The transmission line 7 may include at least one electrical connector in the first accommodating portion 11 and the cable extending from the electrical connector along the end of the first door 1.

The transmission line 7 may include a first electrical connector 71 and a second electrical connector 72 adapted in the first accommodating portion 11, a first part 73 that is connected between the first electrical connector 71 and the related part 108 (such as a main control panel) of the cabinet 101, and a second part 74 that is connected between the second electrical connector 72 and the electrical member 6.

The first part 73 and/or the second part 74 may include the cable and additional electrical connectors.

The first part 73 may pass through the thermal insulation space 15. When the first door 1 is provided with thermal insulation materials, the first part 73 may be embedded in a thermal insulation layer formed by the thermal insulation materials.

The first part 73 may extend from the cabinet 101 into the second hinge hole 16 in the first door 1. Specifically, the first part 73 may extend within the hole defined by the second hinge shaft 42.

The first part 73 extends from the second hinge hole 16 into the first door 1, and connects to the first electrical connector 71 exposed to the first accommodating portion 11.

The second part 74 may extend from the second door 2 toward the end of the first door 1 along the first hinge unit 3, and then extend into the first accommodating portion 11 in the lateral direction of the first door 1. The second electrical connector 72 fixed at the end of the second part 74 is connected to the first electrical connector 71 in the first accommodating portion 11.

Because the first electrical connector 71 and the second electrical connector 72 are connected outside the first hinge unit 3, the first hinge unit 3 may be disposed more compactly. When another electrical part (such as a detector, a temperature sensor, a humidity sensor, or a control circuit board) needs to be disposed at the end of the first door 1, the first electrical connector 71 and the second electrical connector 72 may be disposed in the same accommodating portion with such an electrical part.

For example, the refrigerator 100 may include a detector 5 located at the first door 1. In an implementation, the detector 5 is configured to detect whether the second door 2 is opened relative to the first door 1. In another implementation, the detector 5 may be configured to detect whether the first door 1 is opened relative to the cabinet 101. In still another embodiment, the detector configured to detect whether the first door is opened relative to the cabinet 101 and the detector configured to detect whether the second door 2 is opened relative to the first door 1, are both located at the first door 1.

Apart from a contact mechanical switch, the detector 5 may be a non-contact sensor. For example, the detector 5 may match a magnet located at the cabinet 101 or the second door 2.

The detector 5 may be located at the end of the first door 1. In the embodiment shown in FIG. 1, the detector 5 is located at an upper end portion of the first door 1.

The first door 1 may include the first side 1A close to the rotation axis of the first door 1 and a second side (not shown in the figure) that is far away from the rotation axis of the first door 1 and is opposite to the first side 1A. As to the first side 1A and the second side of the first door 1, the detector 5 may be closer to the first side 1A of the first door 1.

The detector 5 may be located in the first accommodating portion 11, and the detector 5 may be partially or completely accommodated in the first accommodating portion 11.

The first accommodating portion 11 may include a connector 51 connected to the detector 5, and the cable connected to the connector 51 may be alternatively located in the thermal insulation space 15.

The first accommodating portion 11 may be adjacent to the first hinge unit 3, so that the detector 5 is also closer to the first side 1A of the first door 1.

A second accommodating portion 12 for receiving the first hinge unit 3 and the second hinge unit 4 may be disposed at the end of the first door 1. The first hinge unit 3 and the second hinge unit 4 are at least partially located in the second accommodating portion 12. In this way, when viewed from the front, the first hinge unit 3 and the second hinge unit 4 may be covered by the second door 2.

The second accommodating portion 12 is disposed at a position, close to the first side 1A, of the upper end of the first door 1. When the first accommodating portion 11 and the second accommodating portion 12 are located at the top of the first door 1, the second accommodating portion 12 may be concave downward from a top surface of the first door 1. The first accommodating portion 11 may be higher than the second accommodating portion 12.

Portions, connected to the first door 1, of the first hinge unit 3 and the second hinge unit 4 are located in the second accommodating portion 12. In this way, the first hinge unit 3 and the second hinge unit 4 may be covered from the front by the second door 2 located on the front side of the first door 1.

When viewed laterally from the first door 1, the first accommodating portion 11 and the second accommodating portion 12 are adjacent to each other. In an embodiment, the first accommodating portion 11 and the second accommodating portion 12 are connected. An end, adjacent to the second accommodating portion 12, of the first accommodating portion 11, may open toward the second accommodating portion 12.

The second accommodating portion 12 may include a concave portion 18 located between the second hinge hole 16 and the second side 1B of the first door 1. An entrance to the second hinge hole 16 may be higher than a bottom wall of the concave portion 18. The concave portion 18 may be concave downward from the plane in which the entrance to the second hinge hole 16 is located. An end of the first hinge 31 is at least partially accommodated in the concave portion 18.

In the embodiments of the present invention, the transmission line 7 configured to transmit electricity/signals to the electrical member 6 of the second door 2 includes the first connector 71 and the second connector 72 that are connected at the first door 1. The first connector 71 and the second connector 72 are located outside the first hinge unit 3.

The first door 1 includes a first accommodating portion 11 located at an end thereof and a lid 13 configured to cover the first accommodating portion 11. There is a pitch between the first accommodating portion 11 and the first hinge unit 3 in a lateral direction X of the first door. The first connector 71 and the second connector 72 are located in the first accommodating portion 11.

The transmission line 7 may extend into the first door 1 through the hinge hole 16 located in the first door 1 and extend within the first door 1, to provide a distance in the lateral direction X of the first door 1.

The transmission line 7 may extend within the first door 1 in the lateral direction of the first door beyond the first hinge unit 3 and/or beyond the second hinge unit 4 into the first accommodating portion 11, covered by the detachable lid 13, of the first door.

The transmission line 7 laterally extends within the first door 1, so that both lateral and vertical distances may be generated.

The transmission line 7 extends within the first door 1, so that a distance in a height direction along the first door 1 may be further generated.

It should be understood that the description of an extension direction of the transmission line in this application is only limited to the transmission line in a static state on the manufactured refrigerator and should not be limited to the operation process/extension direction of the transmission line on the refrigerator during manufacturing.

Various embodiments illustrated with reference to FIG. 1 to FIG. 3 may be combined with each other in any given manner to realize the advantage of the present invention. In addition, the present invention is not limited to the shown embodiments. Usually, apart from the shown measures, other measures may also be used as long as the measures may also achieve the same effect.

1. A refrigerator, comprising:
a cabinet;
a first door located in front of said cabinet;
a second door located in front of said first door;
an electrical member located at said second door; and
a transmission line connected to said electrical member, said transmission line extending from said cabinet into said first door and extending from said first door toward said second door.

2. The refrigerator according to claim 1, wherein said first door has a thermal insulation space filled with thermal insulation materials, and said transmission line extends into said thermal insulation space.

3. The refrigerator according to claim 1, which further comprises a first hinge unit interconnecting said first door and said second door, said transmission line exiting said first door then entering said first hinge unit and then extending toward said second door.

4. The refrigerator according to claim 3, which further comprises a second hinge unit interconnecting said cabinet and said first door, said transmission line extending through said second hinge unit into said first door.

5. The refrigerator according to claim 4, wherein said transmission line extends within said first door and runs for a distance in a lateral direction of said first door.

6. The refrigerator according to claim 5, wherein said transmission line extends within said first door, and said transmission line at least one of extends in the lateral direction of said first door beyond said first hinge unit interconnecting said first door and said second door or extends beyond said second hinge unit interconnecting said first door and said cabinet to an outside of said first door.

7. The refrigerator according to claim 5, wherein said transmission line extends outward from said first door and then extends laterally to extend toward said second door along with said first hinge unit interconnecting said first door and said second door.

8. The refrigerator according to claim 4, wherein said first door includes a first accommodating portion located at an end of said first door and a lid configured to cover said first accommodating portion, said transmission line extending from said first door to said first accommodating portion and then extending toward said first hinge unit interconnecting said first door and said second door.

9. The refrigerator according to claim 8, wherein said first accommodating portion and said first hinge unit are adjacent to each other and a pitch is provided in a lateral direction of said first door.

10. The refrigerator according to claim 8, wherein said transmission line includes a first electrical connector and a second electrical connector interconnected in said first accommodating portion, and said transmission line includes a cable extending from said second electrical connector into said first hinge unit along said end of said first door.

11. The refrigerator according to claim 8, wherein said lid includes a lid portion extending horizontally and a separator portion configured to separate said first hinge unit from said first accommodating portion in a lateral direction of said first door, said separator portion having a hole for permitting said transmission line to pass through.

12. A refrigerator, comprising:
a cabinet;
a first door located in front of said cabinet;
a second door located in front of said first door;
an electrical member located at said second door;
a first hinge unit interconnecting said first door and said second door; and
a transmission line configured to transmit electricity or signals to said electrical member, said transmission line including a first connector and a second connector being interconnected at said first door, and said first connector and said second connector being located outside of said first hinge unit.

13. The refrigerator according to claim 12, wherein said first door includes a first accommodating portion located at an end of said first door and a detachable lid configured to cover said first accommodating portion, a pitch is disposed between said first accommodating portion and said first hinge unit in a lateral direction of said first door, and said first connector and said second connector are located in said first accommodating portion.

14. The refrigerator according to claim 12, wherein said transmission line extends into said first door through a hinge hole located in said first door and extends within said first door along a distance in a lateral direction of said first door.

15. The refrigerator according to claim 14, which further comprises a second hinge unit interconnecting said first door and said cabinet, said transmission line extending within said first door in the lateral direction of said first door, and said transmission line at least one of extending beyond said first hinge unit interconnecting said first door and said second door or extending beyond said second hinge unit interconnecting said first door and said cabinet into said first accommodating portion located at said first door and covered by said detachable lid.
